(19) United States
(12) Patent Application Publication
(10) Pub. No.: US 2011/0211682 A1
(43) Pub. Date: Sep. 1, 2011

(54) TELEPHONY FRAUD PREVENTION

(75) Inventors: Devinder Singh, Kuala Lumpur (MY); Santeri Kangas, Kuala Lumpur (MY); Christopher Elisan, Cumming, GA (US)

(73) Assignee: F-SECURE OYJ, Helsinki (FI)

(21) Appl. No.: 12/737,498

(22) PCT Filed: Jul. 20, 2009
(86) PCT No.: PCT/EP2009/059290

§ 371 Date: May 2, 2011

(30) Foreign Application Priority Data
Jul. 21, 2008 (MY) PI20082701

(51) Int. Cl. H04M 1/56

(52) U.S. Cl. 379/142.05

(57) ABSTRACT

A method for guarding against telephony-based fraud that includes, at a telephony device, identifying a caller ID of an incoming call or a dialled number of an outgoing call attempt or a number to be dialled. The identified caller ID or dialled number or number to be dialled is then compared against a blacklist of telephone numbers. In the event that a match is found, a warning is presented to a user of the device and/or the call or call attempt is terminated.

### FIELD OF THE INVENTION

The present invention relates to the prevention of telephony fraud and in particular, though not necessarily, to a method and apparatus for providing protection against fraud enacted by automated calling systems.

### BACKGROUND TO THE INVENTION

It is commonplace for financial institutions such as banks to offer financial services over the Internet to their customers. Criminals are keen to exploit the way that the banks provide these services by using the Internet to commit fraud. One of the most common methods employed by criminals is known as the “phishing” attack.

A phishing attack typically involves an “attacker” sending an email claiming to be from a bank and requesting the email recipient to submit sensitive account information for some purpose. Alternatively, the recipient may be asked to click on a link within the email, where the link leads to a malicious website operated by the attacker that is designed to look like a legitimate bank website. The user is thus fooled into entering sensitive information.

The phishing attack is not as effective as it once was due to increased awareness of Internet related fraud amongst the general public. Criminals are therefore looking for new forms of attack. One such attack is known as a “vishing” attack. The vishing attack, in contrast to the phishing attack, uses telephone communication with the customer. An attacker calls the customer and uses various approaches to deceive the customer into believing that the call is from his or her bank. For example, the attacker asks the customer for sensitive account details using the pretence that the information is required to defend the customer against fraudulent activity. The vishing attack takes advantage of the general public's perception that telephone communications can be trusted, as the source of a telephone call can be traced and, as such, criminals would not use telephone communications to commit fraud.

A vishing attacker may use an available service to prevent its caller ID being transmitted to the call recipient. If a call is made in this way the recipient's telephone will display the message “withheld number” and the recipient will have no record regarding the source of the call. However this type of attack suffers from the disadvantage that many people are unlikely to trust a call for which the caller ID is withheld: they will assume that it is a “nuisance” call.

The introduction of Voice over Internet Protocol (VoIP) telephony represents an opportunity for attackers to launch more sophisticated vishing attacks against the public.

A telephone call made using VoIP involves transmitting voice data over an IP network including, for example, the World Wide Web (WWW). A VoIP telephone call can be initiated by and/or received at a computer having an Internet connection, or it can be broken out of (or broken onto) the Internet using a gateway operated by a VoIP service provider. In the case where a VoIP call is terminated at a conventional telephone terminal, the gateway at which the call enters into the telephony network may add a caller ID to the call set-up message. However, this ID cannot be relied upon by the called party as it may be a telephone number injected by the caller or may have no connection with the caller at all, e.g. it may be selected by the gateway without any association with the source. Thus, a simple caller ID check carried out by a victim, either manually or even using the automated caller display features of a phone (based for example upon matching caller IDs to entries in the phone's address book), will not unmask a vishing attack and may even lead to a further deception of the victim.

The VoIP vishing attack therefore allows the attacker to remain anonymous whilst at the same time presenting a seemingly authentic caller ID to the victim—the victim may be unaware that caller IDs can no longer be trusted. At the same time, as VoIP services are extremely cheap and sometimes free, they represent an extremely cost effective form of attack. Where automated VoIP dialing is used (and for example a recorded message requests the victim to enter account details and the like using his/her phone keys), the costs to the attacker are driven still lower and even a very small success rate may merit the investment in making the attack.

As the public become educated regarding the dangers of VoIP vishing attacks, they are likely to become suspicious even of seemingly authentic caller IDs. Banks and the like will advise them to trust only numbers that they dial themselves, and not to trust any incoming calls. Attackers may in turn take advantage of this increased awareness by performing VoIP vishing attacks in which they provide victims with a callback number, i.e. a number claimed to be the bank's number, which, when dialled, requests the victims to enter sensitive data.

### SUMMARY OF THE INVENTION

In order to reduce the threats posed by vishing attacks as much as possible, it is necessary to close, as far as possible, all of the loopholes identified above.

It is an object of the present invention to provide a means for defeating vishing attacks of the type where the attacker provides to the victim a callback number which, when dialled, seeks to collect sensitive data from the victim.

According to a first aspect of the invention, there is provided a method of guarding against telephony-based fraud and comprising at a telephony device, identifying a caller ID of an incoming call or a dialled number of an outgoing call attempt or a number to be dialled; comparing the identified caller ID or dialled number or number to be dialled against a blacklist of telephone numbers; and in the event that a match is found, presenting a warning to a user of the device and/or terminating the call or call attempt.

In an embodiment, the device is a fixed line or mobile telephone, or a computer.

Preferably, in the case of an outgoing call attempt, the method further comprises suspending the call setup procedure at least until said comparison has been performed. More preferably, the method comprises comparing the identified caller ID or dialled number or number to be dialled against a whitelist of telephone numbers and informing the user of the result and/or continuing with any outgoing call attempt.

In an embodiment the method further comprises maintaining said blacklist and, optionally said whitelist, within a memory of or coupled to a remote server, the method further comprising sending said identified caller ID or dialled number or number to be dialled to said server, performing said step of comparing at the server, and returning the result of the comparison to said device. In an alternative embodiment, the method comprises maintaining said blacklist, and optionally said whitelist, at said telephony device, said step of comparing being performed at the device and preferably updating said blacklist, and optionally said whitelist, by delivering updates to the device from a server over a communications network.

Preferably the blacklist contains telephone numbers known to be associated with malicious parties.

According to a second aspect of the invention, there is provided a telephony device configured to identifying a caller ID of an incoming call or a dialled number of an outgoing call attempt or a number to be dialled, initiate a comparison of the identified caller ID or dialled number or number to be dialled against a blacklist of telephone numbers, and, in the event that a match is found, to present a warning to a user of the device and/or terminate the call or call attempt.

Preferably, in the event of an outgoing call attempt, the device is configured to suspend the call set up at least until said comparison has been performed.

More preferably, the device is configured to initiate a comparison of the identified caller ID or dialled number or number to be dialled against a whitelist of telephone numbers, and, in the event that a match is found, to present the result to the user and/or continue with any outgoing call attempt. Furthermore, the device may be configured to initiate said comparison(s) by sending the caller ID or dialled number or number to be dialled to a remote server via a communications network, and further configured to receive back from said server the result of the comparison. The device may also send personal contact details including telephone numbers to the server to be added to the whitelist.

The device may be a mobile telephone, fixed telephone, or computer. In an embodiment in which the device is a mobile telephone useable within a packet data network, the data is exchanged between the device and the server via said packet data network.

According to a third aspect of the invention, there is provided a computer configured to operate as a web server and comprises a memory storing a blacklist of telephone numbers, the computer having an interface for receiving telephone numbers from telephony devices, and processing means for determining if the numbers are present in said blacklist and for returning the results of the comparisons to the respective devices.

Preferably the computer is configured to store within said memory a whitelist of telephone numbers, said processing means determining whether or not a received telephone number is present in said white list and for returning the result to a telephone device.

According to a fourth aspect of the invention, there is provided a method of protecting users of telephony devices against telephone-based fraud, the method comprising installing into users' telephony devices a call monitoring application, registering users with a central server at which is maintained a blacklist of malicious telephone numbers, in the event that an incoming call is received at a user's device or an outgoing call attempt is made, sending the incoming caller ID/dialled number to said server, checking at the server if the caller ID/dialled number is present on the blacklist and, if so, providing a warning to the user and/or terminating the call/call attempt.

### BRIEF DESCRIPTION OF THE DRAWINGS

FIG. 1 illustrates the system architecture of an embodiment;

FIG. 2 is a flowchart detailing steps involved in receiving a telephone call;

FIG. 3 is a flowchart detailing steps involved in making a telephone call; and

FIGS. 4a, 4b, 4c and 4d show a series of screens displayed at a user's mobile phone when a phone call is received and/or made.

### DETAILED DESCRIPTION OF CERTAIN EMBODIMENTS

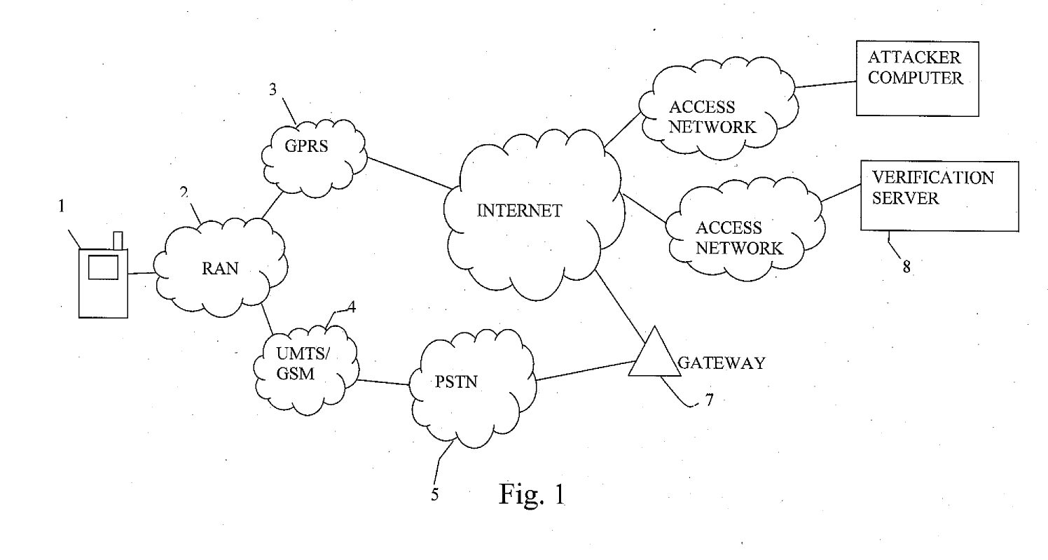

FIG. 1 illustrates a typical communication network architecture used for data and telephonic traffic. A subscriber (of a home network) has a mobile phone 1 that can use a Radio Access Network (RAN) 2 to connect to a Global Packet Radio Service (GPRS) network 3 or a Global System for Mobile communications (GSM) network/Universal Mobile Telecommunications System (UMTS) network 4. The mobile phone 1 makes “standard” telephone calls using the UMTS/GSM network 4 and can access the Internet via the GPRS network 3. If the mobile phone 1 is provided with a suitable VoIP client the mobile phone 1 can make VoIP calls over the Internet, via the GPRS network. Typically however voice calls are made via the UMTS/GSM network.

A verification server 8, operated by the vendor of the security software, accesses the Internet by way of an access network 9. A data connection can be established between the mobile terminal 1 and the verification server 8 via the Internet and the GPRS network 3. The procedures for establishing such data connections, and for exchanging data across them, are well known.

The verification server 8 stores a “whitelist” and “blacklist” of telephone numbers and corresponding company/organisation names (if they are known) in a database. The whitelist includes telephone numbers that have been verified to be associated with trustworthy companies. For example, telephone numbers that belong to a call centre of a bank. The blacklist contains numbers that are known to be malicious or fraudalent in nature. For example, numbers that have been used previously in a vishing attack. These number lists may be global, i.e. applied to all users that have subscribed to a security service, or may be personalised, i.e. populated by the service operator with subscribers having the option of adding trusted phone numbers (e.g. by uploading a personal contact list) to the whitelist.

In the embodiment described here, the mobile phone 1 has a call verification application stored in its memory. The call verification application is responsible for extracting the caller ID from any incoming calls received by the mobile phone 1 and sending the caller ID to the verification server 8 for the purpose of identifying the claimed identity of the caller. The verification server returns this identity, if known to it, to the mobile phone where it is displayed to the user. Of course, this in itself does not protect a user against a “callback” attack, and so the call verification application also intercepts outgoing call attempts, and suspends call initiation whilst it extracts the called number and sends this to the call verification server 8 for verification. The call verification application is arranged to prevent a user from connecting a call until the caller ID has been authenticated.

It will be further appreciated that since the verification process described here is relatively light in terms of its use of the telephone network, i.e. only to transmit and receive the caller ID information, the network is not placed under any significant extra strain.

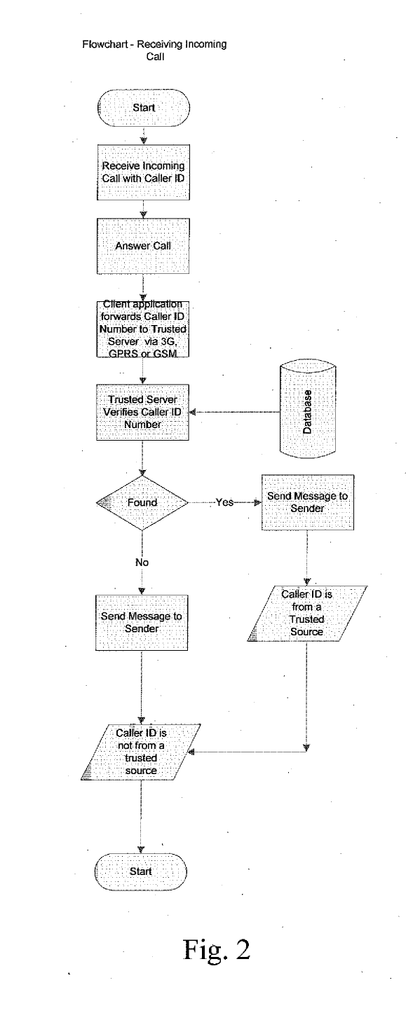

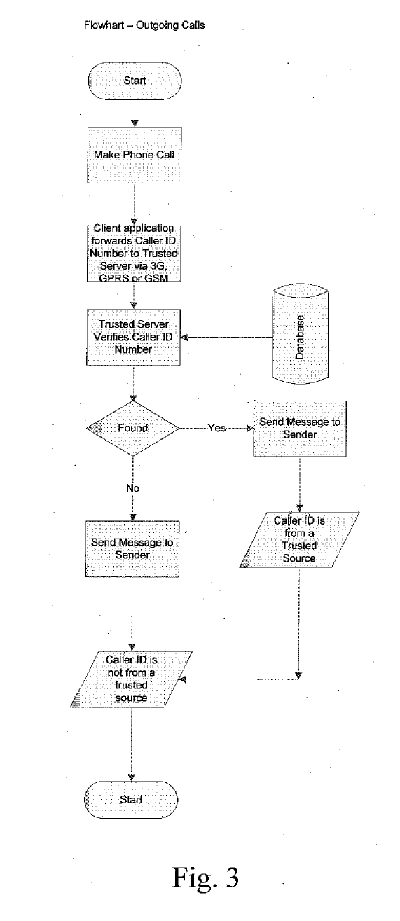

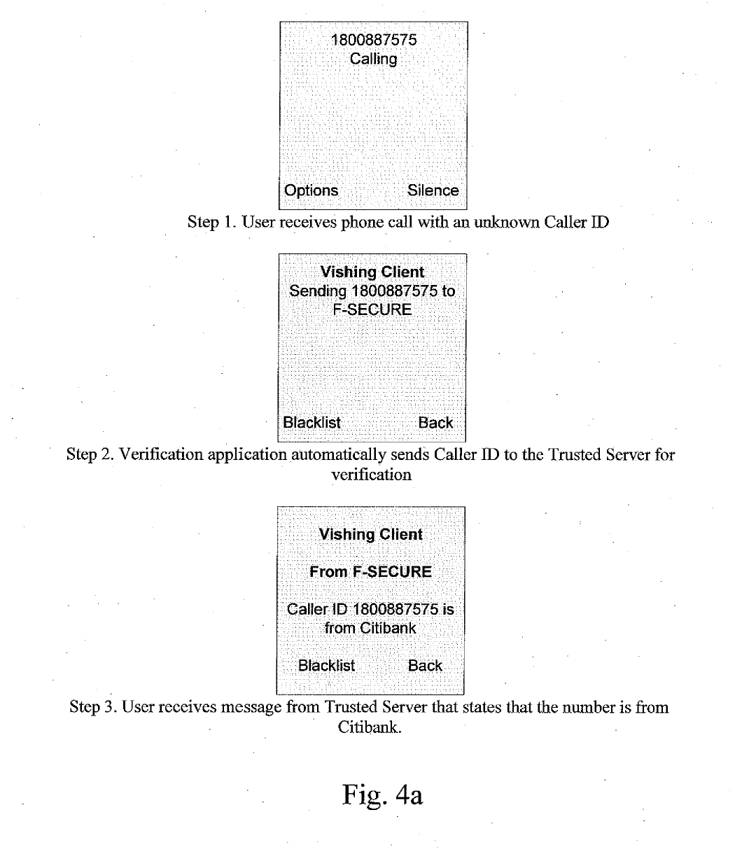

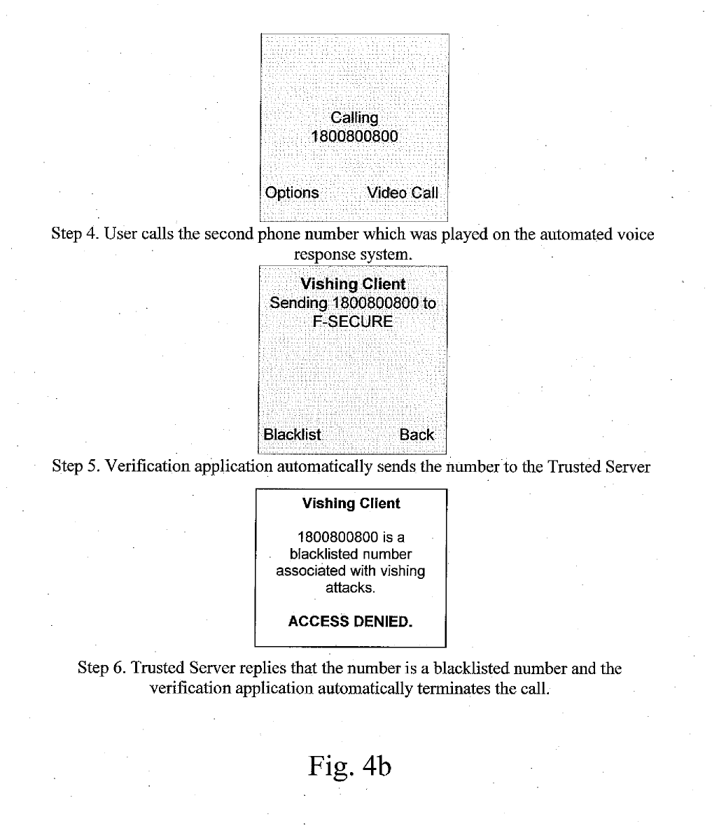

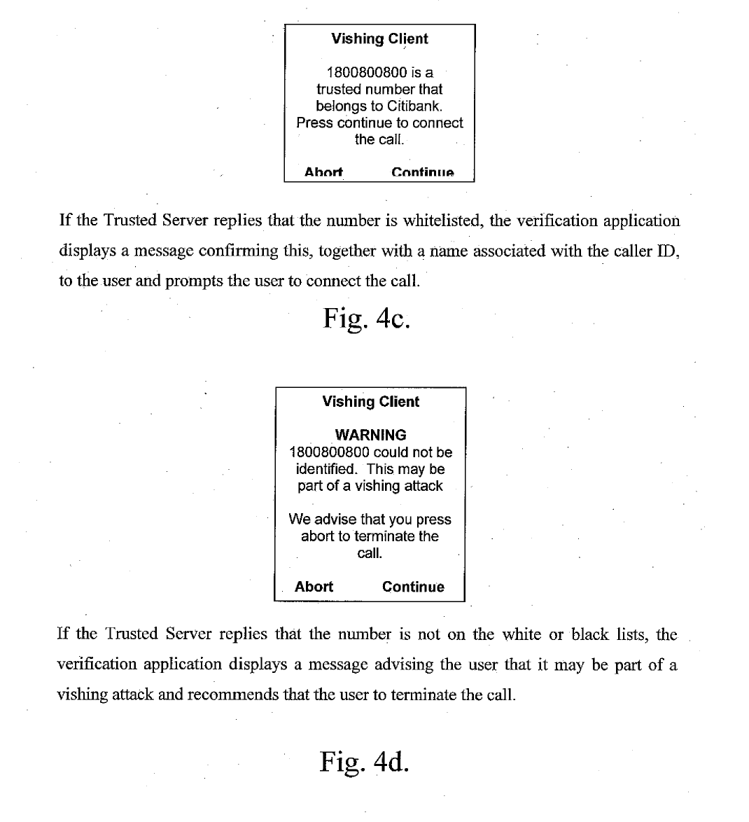

A vishing attack on the mobile phone 1 will now be described with reference to the flowchart in FIGS. 2 and 3 and the screenshot designs of FIGS. 4a and 4b.

Assume that an attacker makes a call to the mobile phone 1 by firstly logging onto some VoIP service provider. This allows the attacker to dial the user's mobile phone 1 and during this process the attacker uses software to inject a false caller ID into the gateway 7. The gateway 7 subsequently breaks out the telephone call onto the PSTN 5 and carries the false caller ID with the call setup message. In this attack the attacker has chosen the caller ID to correspond to that of a legitimate bank.

As illustrated in FIG. 4a (step 1), the mobile phone 1 receives the call and the caller ID is displayed on the mobile phone 1. The caller ID may take the form of a number corresponding to the phone number of the calling party or it may further display a name for the calling party. Assuming that the user chooses to answer the call, the user presses the button for accepting the call and the call verification application is arranged to obtain the caller ID and transmit it to the verification server 8. This is transmitted via the phone's GPRS network as described earlier (the call may be put on hold during this process). As illustrated at step 2, a message is displayed on the mobile phone 1 informing the user that the caller ID is being verified.

The verification server 4 receives the caller ID and runs a search for the caller ID on its database of whitelist and blacklist phone numbers. The search can have three possible results: the caller ID is found on the whitelist, it is found on the blacklist, or it is not found at all. As illustrated at step 3, on completion of the search, a message is sent to the mobile phone 1 detailing the result, i.e. identifying the claimed caller and its status.

In the case illustrated, since the (fake) caller ID actually corresponds to a legitimate bank phone number, the caller ID will be found in the whitelist and the verification application causes the mobile phone 1 to display a message informing the user of the owner of the caller ID. In this case, it would display “Citibank”. However, a warning may be added that the caller ID should not be trusted.

In the event that the caller ID is found on the blacklist, the user is warned against answering the call. The verification server 8 may also keep a record of the vishing attack occurring from the caller ID, including the date, time, and called number. This may be important in identifying particularly active vishing attack numbers and the number could be forwarded to the VoIP provider with which the number is associated. The details of the attack may also provide important evidence for criminal justice agencies to bring about prosecutions against those responsible.

If the caller ID is not found at the verification server 8 on either of the lists, the verification application displays a message informing the user that the caller ID is unknown.

In this example, as the verification process has identified the called ID as allegedly trustworthy, the user answers the call and a recorded message is played. The attacker has pre-recorded the message to request the user to ring a second number. The second number corresponds to a caller ID for a VoIP account owned by the attacker.

Having received information from the verification application that the incoming caller ID is allegedly trustworthy, the user may assume that it is safe to ring the callback number. Accordingly, the user terminates the first call and dials the callback number. The process is illustrated in FIG. 3 and FIG. 4b. The verification application is however arranged to intercept the dialled number and put the call on hold pending further verification. As shown at step 5, the verification application then transmits the dialled phone number to the verification server 8 and the verification server 8 conducts a search for the number.

The whitelist/blacklist check is repeated by the verification server. However, in this example, the check reveals that the dialled number is present on the blacklist. The result is sent to the mobile phone 1 and the verification application displays an appropriate message informing the user of the owner of the caller ID (if known) and a warning that the user is the subject of a vishing attack. This is illustrated in step 6. The verification application may automatically abort the call attempt, or may give the user the opportunity to abort. On the other hand, as illustrated in FIG. 4c, if the verification server finds the dialled number on the whitelist, a message is returned to the mobile phone and the verification application allows the call to proceed. However, if the user notices that the name displayed on the phone, although a whitelisted name, is different to that identified in the previously received call, i.e. Citibank, the user has the option of reporting this as a possible vishing attack.

In the event that the verification server does not find the dialled number on either the whitelist or the blacklist, this may or may not indicate a vishing attack. As illustrated in FIG. 4d, a warning that the dialled number cannot be trusted is returned to the mobile phone. The user has the option to complete the call or not. If the user subsequently suspects that a vishing attack is underway, the verification application provides the option to feed this information back to the application server. If the server receives a number of similar “complaints”, it may blacklist the dialled number.

In an alternative embodiment the verification server 8 is not required and the database (whitelist/blacklist) is stored locally at the mobile phone 1. The verification application can access the database and perform the search itself. However, in order to keep the database up-to-date, regular updates are downloaded from a web server and installed at the mobile phone 1. In addition, any caller IDs that have been blacklisted by the user are forwarded to the server so that its own verification database can be updated and the updates forwarded to other subscribers of the verification service.

The system described above may be made more intelligent by linking in some way the initial vishing call and the callback attempt, and in particular by comparing the claimed incoming caller ID and the callback number. If the “owners” of these two numbers differ, or the owner of the callback number is unknown, then the verification server server can surmise that a vishing attack is underway and alert the user accordingly. The linking of the numbers may require a manual confirmation by the user, e.g. a prompt to confirm that a call is in response to the last (or other) incoming call.

In some cases, an attacker may instigate a vishing attack by first sending an email or SMS (text message) that requests the recipient to call a malicious number listed in the email or SMS. It will be appreciated that the present invention may be applied to defend against such an attack, by verifying the dialled number for the callback attempt.

The skilled person will appreciate that various modifications may be made to the above described embodiments without departing from the scope of the present invention. For example, it will be appreciated that the verification application may be installed within a computer arranged to make and receive calls using a VoIP account.

1. A method of guarding against telephony-based fraud and comprising:
at a remote server, maintaining a blacklist of telephone numbers;
at a telephony device, identifying a dialled number of an outgoing call attempt or a number to be dialled;
comparing the identified dialled number or number to be dialled against the blacklist of telephone numbers; and
in the event that a match is found, presenting a warning to a user of the device and/or terminating the call attempt.

2. A method according to claim 1, wherein said device is a fixed line or mobile telephone, or a computer.

3. A method according claim 1 and comprising suspending the call setup procedure at least until said comparison has been performed.

4. A method according to claim 1 and comprising:
at the remote server, maintaining a whitelist of telephone numbers;
comparing the identified dialled number or number to be dialled against the whitelist of telephone numbers; and
informing the user of the result and/or continuing with any outgoing call attempt.

5. A method according to claim 1 and further comprising sending said identified caller ID or dialled number or number to be dialled to said server, performing said step of comparing at the server, and returning the result of the comparison to said device.

6. A method according to claim 1 and comprising sending said blacklist, and optionally said whitelist, from the remote server to said telephony device, said step of comparing being performed at the device.

7. A method according to claim 6 and comprising updating said blacklist, and optionally said whitelist, by delivering updates to the device from the server over a communications network.

8. A method according to claim 1, wherein said blacklist contain telephone numbers known to be associated with malicious parties.

9. A telephony device configured to identify a dialled number of an outgoing call attempt or a number to be dialled, initiate a comparison of the identified dialled number or number to be dialled against a blacklist of telephone numbers, and, in the event that a match is found, to present a warning to a user of the device and/or terminate the call or call attempt.

10. A device according to claim 9 and configured to suspend the call set up at least until said comparison has been performed.

11. A device according to claim 9 and configured to initiate a comparison of the identified dialled number or number to be dialled against a whitelist of telephone numbers, and, in the event that a match is found, to present the result to the user and/or continue with any outgoing call attempt.

12. A device according to claim 9 and configured to initiate said comparison(s) by sending the dialled number or number to be dialled to a remote server via a communications network, and further configured to receive back from said server the result of the comparison.

13. A device according to claim 11, and configured to initiate said comparison(s) by sending the dialled number or number to be dialled to a remote server via a communications network, and further configured to receive back from said server the result of the comparison and configured to send personal contact details including telephone numbers to the server to be added to the whitelist.

14. A device according to claim 9, the device being a mobile telephone, fixed telephone, or computer.

15. A device according to claim 12, the device being a mobile telephone useable within a packet data network, data being exchanged between the device and the server via said packet data network.

16. A computer configured to operate as a web server and comprising a memory storing a blacklist of telephone numbers, the computer having an interface for receiving telephone numbers from telephony devices, and processing means for determining if the numbers are present in said blacklist and for returning the results of the comparisons to the respective devices.

17. A computer according to claim 16 and configured to store within said memory a whitelist of telephone numbers, said processing means determining whether or not a received telephone number is present in said white list and for returning the result to a telephone device.

18. A method of protecting users of telephony devices against telephone-based fraud, the method comprising installing into users' telephony devices a call monitoring application, registering users with a central server at which is maintained a blacklist of malicious telephone numbers, in the event that an outgoing call attempt is made, sending the dialled number to said server, checking at the server if the dialled number is present on the blacklist and, if so, providing a warning to the user and/or terminating the call/call attempt.
